(19) United States
(12) Patent Application Publication
(10) Pub. No.: US 2026/0081325 A1
(43) Pub. Date: Mar. 19, 2026

(54) BATTERY AND METHOD OF MANUFACTURING SAME

(71) Applicant: SAMSUNG SDI CO., LTD., Yongin-si (KR)

(72) Inventor: Taewoong JANG, Yongin-si (KR)

(21) Appl. No.: 19/059,512

(22) Filed: Feb. 21, 2025

(30) Foreign Application Priority Data
Sep. 13, 2024 (KR) 10-2024-0126203

(51) Int. Cl. H01M 50/595; H01M 10/04; H01M 10/653; H01M 10/659; H01M 50/109; H01M 50/153

(52) U.S. Cl. CPC H01M 50/595; H01M 10/0431; H01M 10/049; H01M 10/653; H01M 10/659; H01M 50/109; H01M 50/153

(57) ABSTRACT

A battery includes an electrode assembly, a case accommodating the electrode assembly, the case including a bottom portion, a side wall portion connected to the bottom portion, and an opening facing the bottom portion, a finishing tape on a surface of the electrode assembly, the finishing tape including a buffer layer and a heat absorbing material, and a cap assembly coupled to one end of the side wall portion to seal the opening.

### CROSS-REFERENCE TO RELATED APPLICATION

The present application claims priority to and the benefit of Korean Application No. 10-2024-0126203, filed on Sep. 13, 2024, in the Korean Intellectual Property Office, the entire disclosure of which is incorporated by reference herein.

### BACKGROUND

### 1. Field

The present disclosure relates to a battery and a method of manufacturing the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

According to some embodiments of the present disclosure, there is provided a battery including an electrode assembly; a case that including a bottom portion, a side wall portion connected to the bottom portion, and an opening facing the bottom portion, and accommodating the electrode assembly; a finishing tape disposed on a surface of the electrode assembly; and a cap assembly coupled to one end of the side wall portion to seal the opening, in which the finishing tape may include a buffer layer including a heat absorbing material.

According to some embodiments of the present disclosure, at least a portion of the buffer layer may be made of a foamed resin substrate, and an inside of the foamed resin substrate may be filled with a heat absorbing material.

According to some embodiments of the present disclosure, the finishing tape is disposed to wrap around at least a portion of a side surface of the electrode assembly facing the side wall portion.

According to some embodiments of the present disclosure, the finishing tape may include a first region contacting a side surface of the electrode assembly and a second region extending from the first region so as to protrude beyond the side surface of the electrode assembly, and the second region may extend toward the opening.

According to some embodiments of the present disclosure, the second region may be folded along an upper surface of the electrode assembly facing the opening.

According to some embodiments of the present disclosure, the second region may be intermittently cut along a side perimeter of the electrode assembly.

According to some embodiments of the present disclosure, the buffer layer may further include a thermally conductive material.

According to some embodiments of the present disclosure, the buffer layer may include a first buffer layer and a second buffer layer disposed on the first buffer layer, the first buffer layer may face the side surface of the electrode assembly, and the second buffer layer may face the side wall portion of the case.

According to some embodiments of the present disclosure, the first buffer layer may further include a thermally conductive material.

According to some embodiments of the present disclosure, an endothermic reaction temperature of the heat absorbing material may be 100 to 300 degrees.

According to some embodiments of the present disclosure, the finishing tape may further include an adhesive layer disposed on at least one side of the buffer layer.

According to some embodiments of the present disclosure, the adhesive layer may include a thermally conductive material.

According to some embodiments of the present disclosure, the electrode assembly may be formed by winding a first electrode, a second electrode, and a separator interposed between the first electrode and the second electrode, and a substrate of the second electrode may be extended and wound to wrap around an outer perimeter of a side surface of the electrode assembly.

According to some embodiments of the present disclosure, there is provided a method of manufacturing a battery, including a step of preparing an electrode assembly; a step of preparing a case including a bottom portion, a side wall portion connected to the bottom portion, and an opening facing the bottom portion; a step of attaching a finishing tape to a surface of the electrode assembly, a step of inserting the electrode assembly into the case; and a step of coupling a cap assembly to one end of the side wall portion to seal the opening, in which the finishing tape may include a buffer layer including a heat absorbing material.

According to some embodiments of the present disclosure, the step of attaching may include a step of disposing the finishing tape to wrap around at least a portion of a side surface of the electrode assembly facing the side wall portion.

According to some embodiments of the present disclosure, the finishing tape may include a first region and a second region extending from the first region, and the step of disposing to wrap around at least a portion of a side surface of the electrode assembly may include a step of disposing a first region to be in contact with the side surface of the electrode assembly, and a second region to protrude beyond the side surface of the electrode assembly toward the opening.

According to some embodiments of the present disclosure, the step of disposing to wrap around at least a portion of a side surface of the electrode assembly may further include a step of folding the second region along an upper surface of the electrode assembly facing the opening.

According to some embodiments of the present disclosure, the second region may be intermittently cut along a side perimeter of the electrode assembly.

According to some embodiments of the present disclosure, at least a portion of the buffer layer may be made of a foamed resin substrate, and an inside of the foamed resin substrate may be filled with a heat absorbing material.

According to some embodiments of the present disclosure, the buffer layer may further include a thermally conductive material.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a cross-sectional view showing an example of a battery according to some embodiments of the present disclosure.

FIGS. 2 to 4 are cross-sectional views showing examples of finishing tapes according to some embodiments of the present disclosure.

FIG. 5 is a perspective view showing an example of an electrode assembly with a finishing tape attached according to some embodiments of the present disclosure.

FIG. 6 is a cross-sectional view showing an example of a battery including an electrode assembly with a finishing tape attached according to some embodiments of the present disclosure.

FIG. 7 is an enlarged cross-sectional view showing an example of a battery including an electrode assembly with a finishing tape attached according to some embodiments of the present disclosure.

FIG. 8 is a perspective view showing an example of an electrode assembly with a finishing tape attached according to some embodiments of the present disclosure.

FIG. 9 is a cross-sectional view showing an example of a battery including an electrode assembly with a finishing tape attached according to some embodiments of the present disclosure.

FIGS. 10 to 12 are enlarged cross-sectional views showing an example of a battery including an electrode assembly with a finishing tape attached according to some embodiments of the present disclosure.

FIG. 13 is a perspective view showing an example of an electrode assembly with a finishing tape attached according to some embodiments of the present disclosure.

FIG. 14 is a perspective view showing an example of a finishing tape being folded according to some embodiments of the present disclosure.

FIG. 15 is a cross-sectional view showing an example of a battery including an electrode assembly with a finishing tape attached according to some embodiments of the present disclosure.

FIG. 16 is an enlarged cross-sectional view showing an example of a battery including an electrode assembly with a finishing tape attached according to some embodiments of the present disclosure.

FIG. 17 is a flowchart illustrating a method of manufacturing a battery according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure.

Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the size, thickness, and relative size and relative thickness of the regions shown in the drawings may be exaggerated for clarity of explanation. That is, the sizes shown in the drawings are only for convenience of understanding and are not limited thereto. In addition, identical reference numerals throughout the specification refer to identical components.

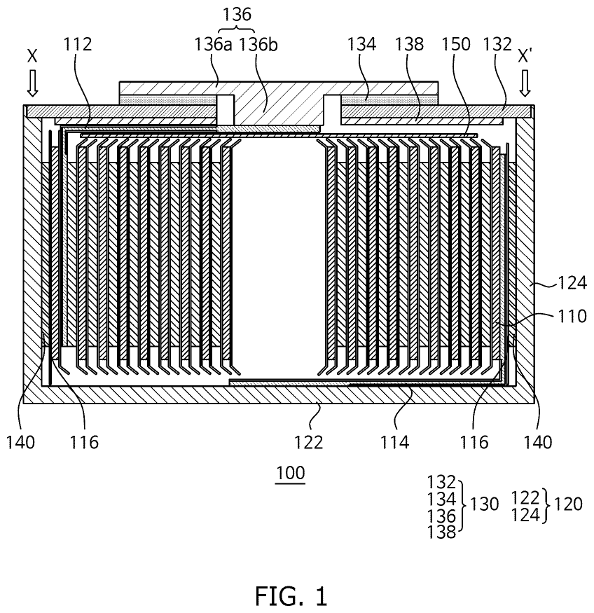

FIG. 1 is a cross-sectional view showing an example of a battery 100 according to an embodiment of the present disclosure. The battery 100 may include an electrode assembly 110, a case 120, a cap assembly 130, a finishing tape 140, and an insulating washer 150.

The battery 100 may be a coin-type battery or a button-type battery. For example, the battery 100 may have a cylindrical shape. In another example, the battery 100 may be a battery of a square shape, a pouch shape, or any suitable shape. For example, the battery 100 may be a secondary battery capable of being charged and discharged.

The electrode assembly 110 may include a first electrode, a second electrode, and a separator. Specifically, the electrode assembly 110 may be formed by winding the first electrode, the second electrode, and a separator interposed between the first electrode and the second electrode. The electrode assembly 110 may be wound to form a core, and may include a through hole in the core.

The first electrode may include a first substrate and a first active material layer positioned on the first substrate. A first electrode tab 112 may extend outward from a first non-coated portion of the first substrate in which the first active material layer is not positioned, and the first electrode tab 112 may be electrically connected to a terminal plate 136 of the cap assembly 130.

The second electrode may include a second substrate and a second active material layer positioned on the second substrate. In an embodiment, a second electrode tab may extend outward from a second non-coated portion of the second substrate in which the second active material layer is not positioned, and the second electrode tab may be electrically connected to the case 120. In another example, the second substrate may be electrically connected directly to the case 120 without the second electrode tab.

The first electrode may function as a positive electrode. In this case, the first substrate may be made of, for example, aluminum foil, and the first active material layer may include, for example, a transition metal oxide. The second electrode may function as a negative electrode. In this case, the second substrate may be made of, for example, copper foil or nickel foil, and the second active material layer may include, for example, graphite.

The separator may function to prevent short circuiting between the first electrode and the second electrode while allowing movement of lithium ions. The separator may be made of, for example, a polyethylene film, a polypropylene film, a polyethylene-polypropylene film, or the like, but is not limited thereto.

The case 120 may accommodate the electrode assembly 110 and an electrolyte. The case 120 may include a bottom portion 122, a side wall portion 124 connected to the bottom portion 122, and an opening facing the bottom portion 122. The electrode assembly 110 may be inserted through the opening in the case 120. The case 120 may be formed in a substantially cylindrical shape or any other suitable shape, e.g., a square shape or a pouch shape. Additionally, the case 120 may be made of a metal such as aluminum, aluminum alloy, nickel-plated steel, or stainless steel, or a laminate film or plastic forming a pouch.

The opening of the case 120 may be sealed by being combined with the cap assembly 130. The cap assembly 130 may include a cap plate 132, an insulating layer 134, the terminal plate 136, and an insulating member 138. Here, the cap plate 132 may cover the opening of the case 120. The cap plate 132 may be coupled to one end of the side wall portion 124 of the case 120 corresponding to the opening. The case 120 and the cap plate 132 may be combined by welding at the welding areas X, X′.

An insertion groove may be formed in the cap plate 132. For example, the insertion groove may be formed at the center of the cap plate 132. The terminal plate 136 (e.g., an insertion portion 136b of the terminal plate) may be inserted into the insertion groove so that the terminal plate 136 may be coupled to the cap plate 132. The terminal plate 136 may include a body portion 136a and the insertion portion 136b protruding from the body portion 136a. Here, the insertion portion 136b of the terminal plate 136 may be inserted into the insertion groove of the cap plate 132. Additionally, the insertion portion 136b of the terminal plate 136 may be connected by making contact with the first electrode tab 112. Referring to FIG. 1, the insertion portion 136b may be disposed to face the electrode assembly 110, so that the cap assembly 130 including the terminal plate 136 may be coupled with the case 120.

The insulating layer 134 may be disposed between the terminal plate 136 and the cap plate 132. The insulating layer 134 may have adhesive strength and may bond the terminal plate 136 and the cap plate 132. The insulating layer 134 may be made of an insulating material and may electrically insulate the terminal plate 136 and the cap plate 132.

In an embodiment, the insulating member 138 may be disposed on the lower surface of the cap plate 132. Here, the upper surface of the cap plate 132 may face the body portion 136a of the terminal plate 136, and the lower surface of the cap plate 132 may face the electrode assembly. The insulating member 138 may be made of an insulating material and may insulate the cap plate 132 and the electrode assembly 110, and may insulate the cap plate 132 and the first electrode tab 112.

In an embodiment, the outer perimeter of the electrode assembly 110 may be finished with a negative electrode substrate. For example, in the electrode assembly 110, the second substrate of the second electrode may be extended and wound to wrap around the outer perimeter of the electrode assembly 110. In another embodiment, the electrode assembly 110 may include a separate negative electrode substrate 116 wrapping around the outer periphery of the electrode assembly 110. Here, the negative electrode substrate 116 may be made of the same material as the substrate of the second electrode. Due to the negative electrode substrate 116 wrapping around the outer periphery of the electrode assembly 110, one end of the separator of the electrode assembly 110 may be spaced apart from the welding areas X, X′. Similarly, due to the negative electrode substrate 116, the first electrode tab 112 of the electrode assembly 110 may be spaced apart from the welding areas X, X′. This prevents the separator from being caught between the case 120 and the cap assembly 130 or from being damaged by welding in the welding areas X, X′. Additionally, a short circuit that may occur due to damage to the first electrode tab 112 caused by welding in the welding areas X, X′ may be prevented.

In an embodiment, the first electrode tab 112 may be folded along the upper surface of the electrode assembly 110 to come into contact with the terminal plate 136. The folded first electrode tab 112 may be prevented from being short-circuited with the electrode assembly 110 by the insulating washer 150. The insulating washer 150 may be disposed between the electrode assembly 110 and the terminal plate 136. For example, the insulating washer 150 may be disposed between the first electrode tab 112 located below the terminal plate 136 and the electrode assembly 110. The insulating washer 150 may include an insulating material. The insulating washer 150 may separate the first electrode tab 112 and the electrode assembly 110. Additionally, the insulating washer 150 may electrically insulate the first electrode tab 112 and the electrode assembly 110.

In an embodiment, the finishing tape 140 may be disposed on the surface of the electrode assembly 110. For example, the finishing tape 140 may be disposed on at least a portion of the side surface of the electrode assembly 110 facing the side wall portion 124 of the case 120, e.g., the finishing tape 140 may be between a lateral side of the electrode assembly 110 and the side wall portion 124 of the case 120.

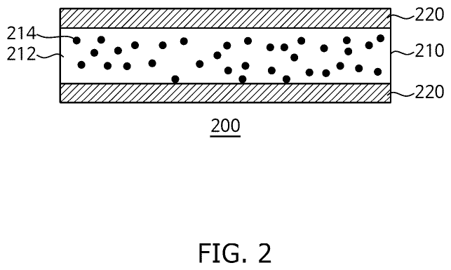

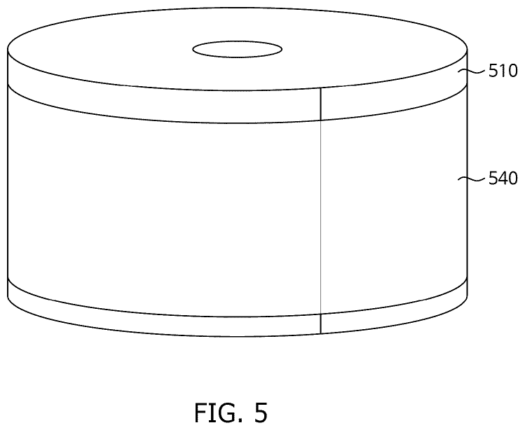

In an embodiment, the finishing tape 140 may be made of an impact-resistant material. Accordingly, the finishing tape 140 may prevent movement of the electrode assembly 110 while absorbing shock applied from the outside of the battery 100. Additionally, the finishing tape 140 may include a heat absorbing material. Accordingly, the finishing tape 140 may absorb heat generated inside and outside the battery. The structure of the finishing tape 140 will be described in detail later with reference to FIGS. 2 to 4. Additionally, examples of attaching the finishing tape 140 will be described in detail later with reference to FIGS. 5 to 16.

FIG. 2 is a cross-sectional view showing an example of a finishing tape 200 according to some embodiments of the present disclosure. The finishing tape 200 of FIG. 2 may correspond to (e.g., be the same as) the finishing tape 140 of FIG. 1.

As illustrated in FIG. 2, the finishing tape 200 may include a buffer layer 210 and an adhesive layer 220. The adhesive layer 220 may be disposed on at least one side of the buffer layer 210.

In an embodiment, at least a portion of the buffer layer 210 may be made of a foamed resin substrate 212. The foamed resin substrate 212 may be made of a polymer material having water resistance or oil resistance mixed with a crosslinking agent. For example, the polymer material applied to the foamed resin substrate 212 may include polyurethane resins which are polymers of polyol and polyfunctional isocyanate, polyolefin resins such as polyethylene and polypropylene, styrene block copolymer polymers such as styrene-butadiene-styrene-block copolymer polymers and styrene-isobutylene-styrene-block copolymer polymers, ethylene copolymer polymers such as ethylene-vinyl acetate, ethylene-ethyl acrylate, and ethylene-methyl methacrylate, acrylic block copolymer polymers such as methyl methacrylate-butyl acrylate-methyl methacrylate, acrylic ester copolymers copolymerized with 2-ethylhexyl acrylate or methyl acrylate, halogenated polymers such as polyvinyl chloride, and the like.

The buffer layer 210 may include a heat absorbing material 214. For example, the inside of the foamed resin substrate 212 configuring the buffer layer 210 may be filled with the heat absorbing material 214 in the form of particles, e.g., the heat absorbing material 214 in the form of particles may be uniformly dispersed in the buffer layer 210.

In an embodiment, the endothermic reaction temperature of the heat absorbing material 214 may be 100 degrees to 300 degrees, e.g., 150 degrees to 200 degrees. Accordingly, before the separator and/or the ceramic coating on the surface of the separator configuring the electrode assembly is melted by the heat generated inside the battery, heat may be absorbed by the heat absorbing material 214. For example, the heat absorbing material 214 may include Ga(NO3)₃, Al(OH)₃, Mg₅(CO₃)₄(OH)₂·4H₂O, NaAl(OH)₂CO₃, Mg(OH)₂, MgO·CO_{2(0.96)}H2O 0.3, AlO(OH), Ca(OH)₂, etc.

In an embodiment, the finishing tape 200 may be formed to a thickness greater than a certain level so as to ensure impact resistance. In addition, because the finishing tape 200 does not contribute to the capacity of the battery, the finishing tape 200 may be formed to a certain thickness or less for the energy efficiency of the battery. For example, the thickness of the finishing tape 200 may be 50μm to 200μm. Additionally, the thickness of the buffer layer 210 may be 30μm to 60μm.

For example, referring to FIG. 2, the adhesive layer 220 may be disposed on both sides (e.g., opposite sides) of the buffer layer 210. In another example, the adhesive layer 220 may be disposed on only one side of the buffer layer 210.

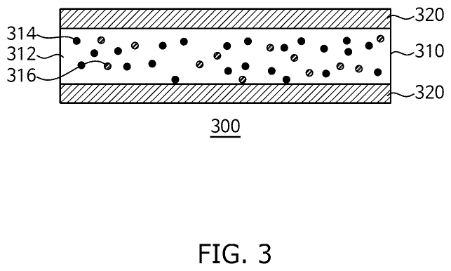

FIG. 3 is a cross-sectional view showing an example of a finishing tape 300 according to some embodiments of the present disclosure. The finishing tape 300 of FIG. 3 may correspond to (e.g., be the same as) the finishing tape 140 of FIG. 1.

As illustrated in FIG. 3, the finishing tape 300 may include a buffer layer 310 and an adhesive layer 320. The adhesive layer 320 may be disposed on at least one side of the buffer layer 310. In FIG. 3, configurations that are described with reference to FIG. 2 or duplicated in FIG. 2 are omitted, and the description is centered on configurations that are different from FIG. 2.

The buffer layer 310 may include a heat absorbing material 314 and a thermally conductive material 316. For example, at least a portion of the buffer layer 310 may be made of a foamed resin substrate 312, and the inside of the foamed resin substrate 312 may be filled with a heat absorbing material 314 and a thermally conductive material 316 in the form of particles. The foamed resin substrate 312 and the heat absorbing material 314 may be substantially the same as those described with reference to FIG. 2. Examples of the thermally conductive material 316 may include alumina, silica, titania, zirconia, chromite, zirconium oxide, magnesium oxide, magnesium hydroxide, aluminum hydroxide, silicon carbide, titanium carbide, silicon nitride, aluminum nitride, boron nitride, or the like.

By this configuration, heat generated inside the battery may be effectively transferred to the finishing tape 300 by the thermally conductive material 316 inside the finishing tape 300. In addition, an increase in the temperature inside the battery may be prevented by the heat transferred to the finishing tape 300 causing the heat absorbing material 314 inside the finishing tape 300 to react.

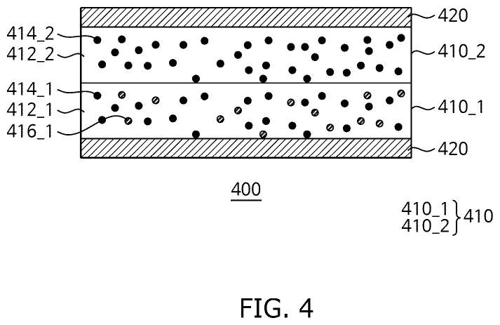

FIG. 4 is a cross-sectional view showing an example of a finishing tape 400 according to some embodiments of the present disclosure. The finishing tape 400 of FIG. 4 may correspond to (e.g., be the same as) the finishing tape 140 of FIG. 1. In FIG. 4, configurations that are previously described with reference to FIGS. 2 and 3 or duplicated in FIGS. 2 and 3 are omitted, and the description is centered on configurations that are different from FIGS. 2 and 3.

As illustrated in FIG. 4, the finishing tape 400 may include a buffer layer 410 and an adhesive layer 420 disposed on at least one side of the buffer layer 410. Here, the buffer layer 410 may include a first buffer layer 410_1 and a second buffer layer 410_2.

The first buffer layer 410_1 may include a first heat absorbing material 414_1 and a thermally conductive material 416_1, and the second buffer layer 410_2 may include a second heat absorbing material 414_2. For example, at least a portion of the first buffer layer 410_1 may be made of a first foamed resin substrate 412_1, and the inside of the first foamed resin substrate 412_1 may be filled with the first heat absorbing material 414_1 and the thermally conductive material 416_1 in the form of particles. In addition, at least a portion of the second buffer layer 410_2 may be made of a second foamed resin substrate 412_2, and the inside of the second foamed resin substrate 412_2 may be filled with the second heat absorbing material 414_2 in the form of particles.

In an embodiment, the finishing tape 400 may be attached to the surface of the electrode assembly. The finishing tape 400 may be interposed between the side surface of the electrode assembly and the inner surface of the case to prevent the electrode assembly from moving inside the case. In this case, the first buffer layer 410_1 of the finishing tape 400 may be disposed to face the side surface of the electrode assembly, and the second buffer layer 410_2 may be disposed to face the inner surface of the case (e.g., the second buffer layer 410_2 may be disposed between the first buffer layer 410_1 and the inner surface of the case).

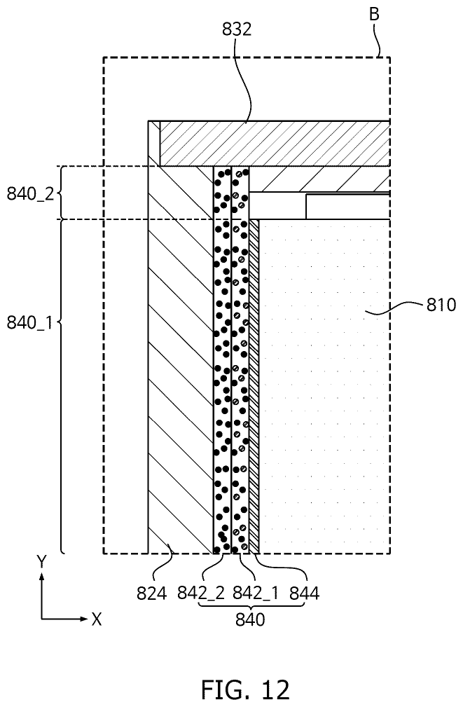

By this configuration, heat generated inside the battery may be quickly transferred to the finishing tape 400 by the thermally conductive material 416_1 of the first buffer layer 410_1 and absorbed by the first heat absorbing material 414_1 of the first buffer layer 410_1. In addition, because the second buffer layer 410_2 of the finishing tape 400 is disposed to face the inner surface of the case, heat generated outside the battery may be absorbed by the second heat absorbing material 414_2 of the second buffer layer 410_2 before being transferred to the electrode assembly. An example in which the finishing tape 400 is attached to the surface of the electrode assembly will be described in detail later with reference to FIG. 12.

For example, referring to FIG. 4, the buffer layer 410 may include two buffer layers (e.g., a first buffer layer 410_1 and a second buffer layer 410_2). In another example, the buffer layer 410 may have a structure in which three or more buffer layers are stacked.

FIG. 5 is a perspective view showing an example of an electrode assembly 510 with a finishing tape 540 attached according to some embodiments of the present disclosure. Each of the finishing tape 540 and the electrode assembly 510 of FIG. 5 may correspond to the finishing tape 140 and the electrode assembly 110 of FIG. 1. As illustrated, the finishing tape 540 may be disposed to wrap around at least a portion of the side surface of the electrode assembly 510. For example, the finishing tape 540 may be disposed to wrap around the side surface of the electrode assembly 510 at least once. In another example, the finishing tape 540 may be disposed to wrap less than one turn around the side of the electrode assembly 510 to cover the winding end of the electrode assembly 510.

In an embodiment, the width of the finishing tape 540 in the height direction of the electrode assembly 510 (e.g., in the winding axis direction of the electrode assembly 510) may be less than or equal to the height of the electrode assembly 510.

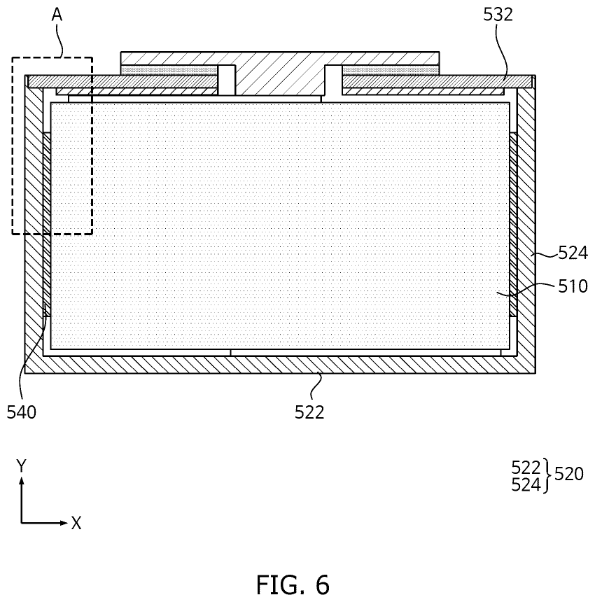

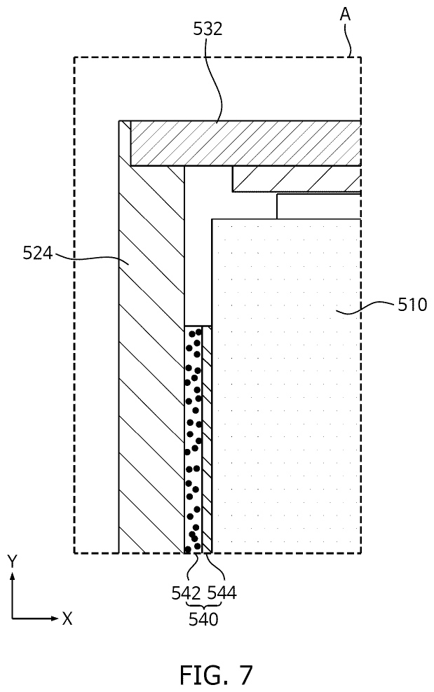

FIG. 6 is a cross-sectional view showing an example of a battery including the electrode assembly 510 with the finishing tape 540 attached thereto according to some embodiments of the present disclosure, and FIG. 7 is an enlarged cross-sectional view showing an example of the battery including the electrode assembly 510 with the finishing tape 540 attached thereto according to some embodiments of the present disclosure. Each of the finishing tape 540 and the electrode assembly 510 of FIGS. 6-7 may correspond to the finishing tape 140 and the electrode assembly 110 of FIG. 1. For reference, FIG. 7 is an enlarged cross-sectional view of area A of FIG. 6.

Referring to FIG. 6, the electrode assembly 510 with the finishing tape 540 attached thereto may be inserted into the interior of a case 520. The case 520 may include a bottom portion 522, a side wall portion 524 connected to the bottom portion 522, and an opening facing the bottom portion 522. A cap plate 532 may be coupled with one end of the side wall portion 524 to seal the opening.

The finishing tape 540 may be attached to the surface of the electrode assembly 510. The finishing tape 540 may be interposed between the side surface of the electrode assembly 510 and the side wall portion 524 of the case 520.

Referring to FIG. 7, the finishing tape 540 may include a buffer layer 542 and an adhesive layer 544 disposed on one surface of the buffer layer 542. The adhesive layer 544 may be disposed to face (e.g., and directly contact) the side surface of the electrode assembly 510, and the buffer layer 542 may be disposed to face (e.g., and directly contact) the side wall portion 524 of the case 520. In this case, even when the buffer layer 542 is not adhered to the side wall portion 524 of the case 520, the position of the electrode assembly 510 may be fixed due to expansion of the electrode assembly 510, etc., and movement of the electrode assembly 510 may be prevented.

In another embodiment, the finishing tape 540 may include the buffer layer 542 and the adhesive layer 544 disposed on both sides of the buffer layer 542. In this case, the electrode assembly 510 and the side wall portion 524 of the case 520 may be bonded by the adhesive layer 544, thereby preventing the electrode assembly 510 from moving.

In an embodiment, the buffer layer 542 of the finishing tape 540 may be made of a material having impact resistance. For example, at least a portion of the buffer layer 542 may be made of a foamed resin substrate. Accordingly, an external force transferred to the electrode assembly 510 due to vibration, dropping, or external impact of the battery may be absorbed by the finishing tape 540, thereby minimizing damage to the electrode assembly 510.

In an embodiment, the buffer layer 542 of the finishing tape 540 may include a heat absorbing material. For example, the inside of the foamed resin substrate configuring the buffer layer 542 may be filled with the heat absorbing material in the form of particles. Heat generated inside the battery by the chemical reaction of the battery may be absorbed by the heat absorbing material inside the buffer layer 542. Accordingly, the temperature inside the battery may be prevented from rising above a certain temperature, thereby preventing thermal runaway or battery short-circuiting phenomena.

In an embodiment, the adhesive layer 544 of the finishing tape 540 may include a thermally conductive material. Accordingly, heat generated in the electrode assembly 510 may be effectively transferred to the buffer layer 542 via the adhesive layer 544.

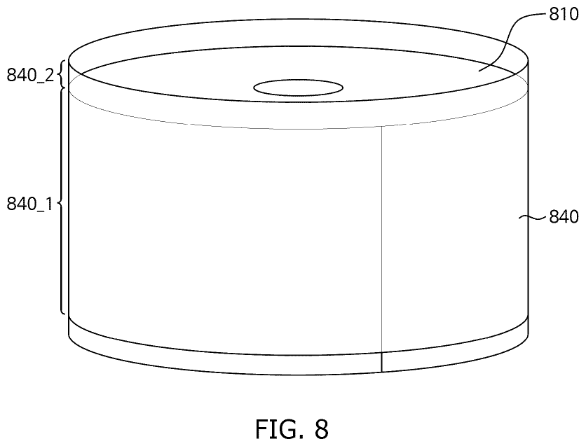

FIG. 8 is a perspective view showing an example of an electrode assembly 810 with a finishing tape 840 attached according to some embodiments of the present disclosure. The finishing tape 840 of FIG. 8 may correspond to the finishing tape 140 of FIG. 1. As illustrated, the finishing tape 840 may be disposed to wrap around at least a portion of the side surface of the electrode assembly 810.

In an embodiment, the finishing tape 840 may include a first region 840_1 in contact with the side surface of the electrode assembly 810 and a second region 840_2 extending from the first region 840_1. The second region 840_2 may protrude beyond (e.g., above) the side surface of the electrode assembly 810 based on the height direction of the electrode assembly 810 (e.g., the winding axis direction of the electrode assembly 810). In this case, the second region 840_2 of the finishing tape 840 may extend toward the opening side of the case while the electrode assembly 810 is inserted into the case, e.g., the first and second regions 840_1 and 840_2 may be coplanar with each other. In other words, the electrode assembly 810 may be inserted such that the second region 840_2 of the finishing tape 840 faces the opening side of the case.

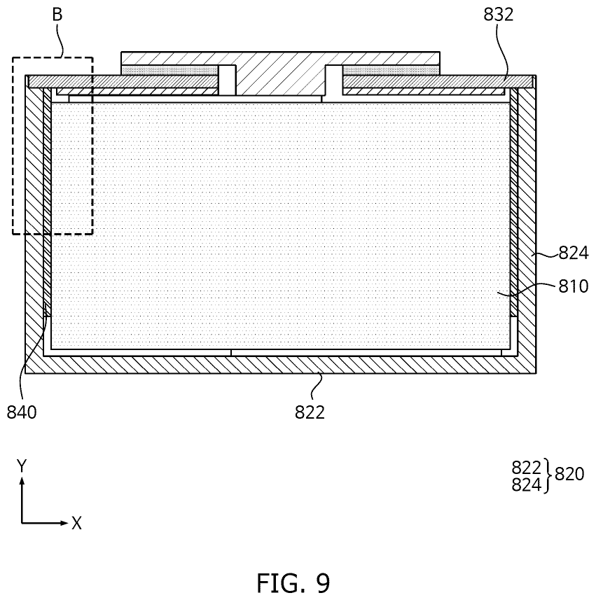

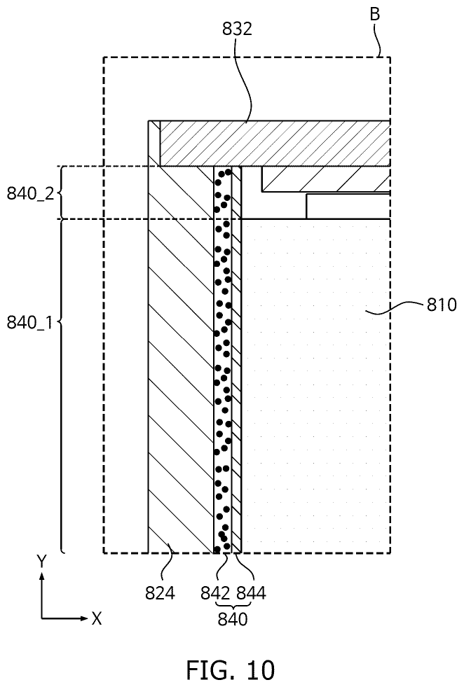

FIG. 9 is a cross-sectional view showing an example of a battery including the electrode assembly 810 with the finishing tape 840 attached thereto according to some embodiments of the present disclosure, and FIGS. 10 to 12 are enlarged cross-sectional views showing examples of a battery including the electrode assembly 810 with the finishing tape 840 attached thereto according to some embodiments of the present disclosure. For reference, FIGS. 10 to 12 are enlarged cross-sectional views of area B of FIG. 9.

Referring to FIG. 9, the electrode assembly 810 with the finishing tape 840 attached thereto may be inserted into the interior of a case 820. The case 820 may include a bottom portion 822, a side wall portion 824 connected to the bottom portion 822, and an opening facing the bottom portion 822. A cap plate 832 in the cap assembly may be coupled with one end of the side wall portion 824 to seal the opening. The cap plate 832 may be welded to one end of the side wall portion 824.

The finishing tape 840 may be attached to the surface of the electrode assembly 810. The finishing tape 840 may be attached so as to protrude beyond the side surface of the electrode assembly 810 based on the height direction of the electrode assembly 810 (e.g., Y-axis direction). The finishing tape 840 may protrude toward the opening side of the case 820 while the electrode assembly 810 is inserted into the case 820.

Additionally, the finishing tape 840 may be interposed between the side surface of the electrode assembly 810 and the side wall portion 824 of the case 820.

Referring to FIG. 10, the finishing tape 840 may include a buffer layer 842 including a heat absorbing material and an adhesive layer 844 disposed on at least one side of the buffer layer 842.

In an embodiment, the finishing tape 840 may include the first region 840_1 in contact with the side surface of the electrode assembly 810 and the second region 840_2 extending from the first region 840_1. The second region 840_2 may extend toward the opening side of the case while the electrode assembly 810 is inserted into the case, and may protrude beyond the side surface of the electrode assembly 810. For example, the second region 840_2 may extend as far as possible to a position where it contacts the cap plate 832. For example, both the buffer layer 842 and the adhesive layer 844 may be disposed in each of the first and second regions 840_1 and 840_2 of the finishing tape 840.

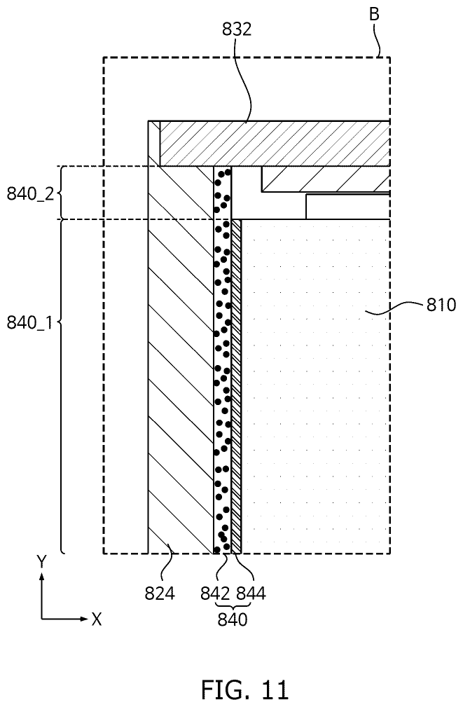

Referring to FIG. 11, the finishing tape 840 may include the buffer layer 842 including a heat absorbing material and the adhesive layer 844 disposed on at least one side of the buffer layer 842. In this case, the buffer layer 842 of the finishing tape 840 may be extended to protrude beyond (e.g., in the Y-axis) the side surface of the electrode assembly 810. For example, both the buffer layer 842 and the adhesive layer 844 may be disposed in the first region 840_1 of the finishing tape 840 in contact with the side surface of the electrode assembly 810, and only the buffer layer 842 may be disposed in the second region 840_2 that protrudes beyond the side surface of the electrode assembly 810.

By this configuration, the finishing tape 840 may be extended to protrude beyond the side surface of the electrode assembly 810, so that heat generated in the welding area of the side wall portion 824 of the case and the cap plate 832 may be prevented from being transferred to the inside of the electrode assembly 810 or the battery.

Referring to FIG. 12, the finishing tape 840 may include a first buffer layer 842_1, a second buffer layer 842_2, and the adhesive layer 844. In an embodiment, the first buffer layer 842_1 may include a heat absorbing material and a thermally conductive material, and the second buffer layer 842_2 may include a heat absorbing material.

In an embodiment, the first buffer layer 842_1 of the finishing tape 840 may be disposed to face the side surface of the electrode assembly 810. For example, the second buffer layer 842_2 may be disposed on one surface of the first buffer layer 842_1, and the other surface of the first buffer layer 842_1 may be disposed to face the side surface of the electrode assembly 810. Additionally, the second buffer layer 842_2 of the finishing tape 840 may be disposed to face the inner surface of the side wall portion 824 of the case. For example, the first buffer layer 842_1 may be disposed on one surface of the second buffer layer 842_2, and the other surface of the second buffer layer 842_2 may be disposed to face the inner surface of the side wall portion 824 of the case.

By this configuration, heat generated in the electrode assembly 810 may be quickly transferred to the finishing tape 840 by the thermally conductive material of the first buffer layer 842_1 and absorbed by the heat absorbing material of the first buffer layer 842_1. In addition, because the second buffer layer 842_2 of the finishing tape 840 is disposed to face the inner surface of the case, heat generated outside the battery may be absorbed by the heat absorbing material of the second buffer layer 842_2 before being transferred to the electrode assembly 810. For example, heat generated in the welding area of the side wall portion 824 of the case and the cap plate 832 may be prevented from being transferred to the first buffer layer 842_1 of the finishing tape 840.

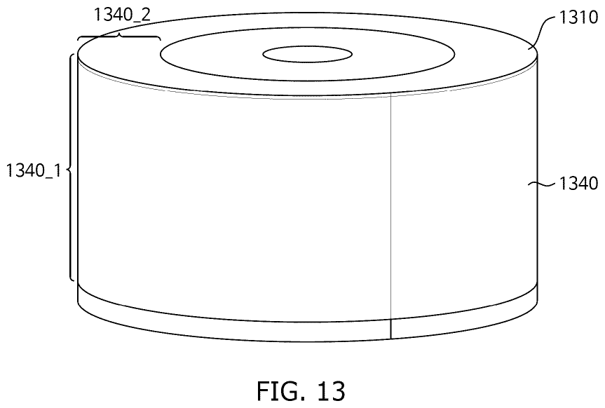

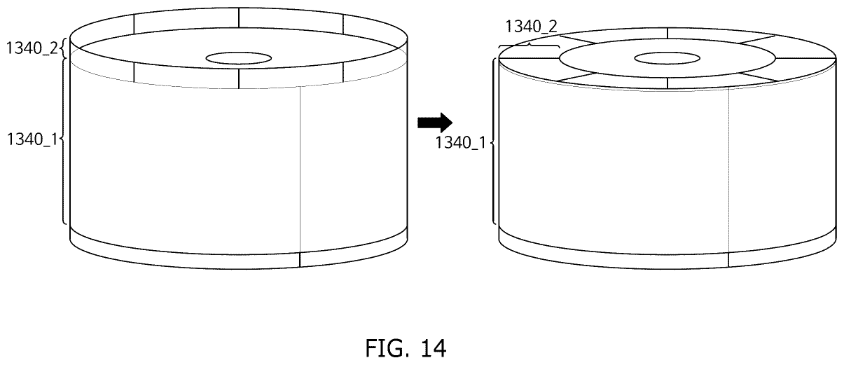

FIG. 13 is a perspective view showing an example of an electrode assembly 1310 having a finishing tape 1340 attached thereto according to some embodiments of the present disclosure, and FIG. 14 is a perspective view showing an example of the finishing tape 1340 being folded according to some embodiments of the present disclosure.

Referring to FIG. 13, the finishing tape 1340 may be disposed to wrap around at least a portion of the side surface and upper surfaces of the electrode assembly 1310.

Here, the upper surface of the electrode assembly 1310 may refer to a surface that is disposed on the opening side of the case while the electrode assembly 1310 is inserted into the case.

In an embodiment, the finishing tape 1340 may include a first region 1340_1 and a second region 1340_2. The first region 1340_1 of the finishing tape 1340 may be disposed to wrap around at least a portion of the side surface of the electrode assembly 1310, and the second region 1340_2 of the finishing tape 1340 may be disposed to wrap around at least a portion of the upper surface of the electrode assembly 1310.

Referring to FIG. 14, the finishing tape 1340 may be attached so as to protrude beyond the side surface of the electrode assembly 1310 based on the height direction of the electrode assembly 1310 (e.g., the winding axis direction of the electrode assembly 1310). For example, the first region 1340_1 of the finishing tape 1340 may be in contact with a side surface of the electrode assembly 1310, and the second region 1340_2 extending from the first region 1340_1 may protrude beyond the side surface of the electrode assembly 1310. Thereafter, the second region 1340_2 of the finishing tape 1340 may be folded along the upper surface of the electrode assembly 1310, e.g., the first and second regions 1340_1 and 1340_2 may be perpendicular to each other. The second region 1340_2 of the finishing tape 1340 folded along the upper surface of the electrode assembly 1310 may be attached to at least a portion of the upper surface of the electrode assembly 1310 or may cover at least a portion of the upper surface of the electrode assembly 1310 in a folded state.

In an embodiment, the second region 1340_2 of the finishing tape 1340 may be intermittently cut along the side perimeter of the electrode assembly 1310. Accordingly, when the second region 1340_2 of the finishing tape 1340 is folded, wrinkles or lifting of the finishing tape 1340 may be prevented.

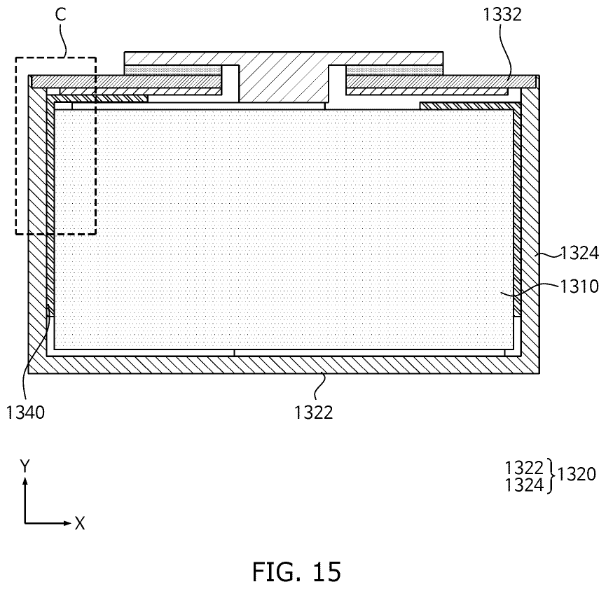

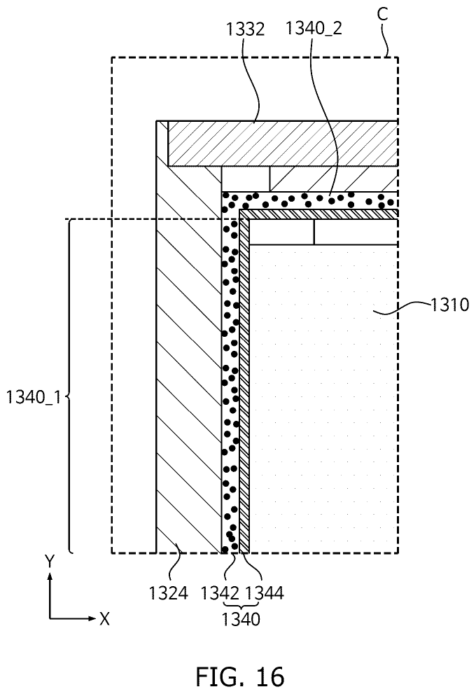

FIG. 15 is a cross-sectional view showing an example of a battery including the electrode assembly 1310 with the finishing tape 1340 attached thereto according to some embodiments of the present disclosure, and FIG. 16 is an enlarged cross-sectional view showing an example of the battery including the electrode assembly 1310 with the finishing tape 1340 attached thereto according to some embodiments of the present disclosure. For reference, FIG. 16 is an enlarged cross-sectional view of area C of FIG. 15.

Referring to FIG. 15, the electrode assembly 1310 with the finishing tape 1340 attached thereto may be inserted into the interior of a case 1320. The case 1320 may include a bottom portion 1322, a side wall portion 1324 connected to the bottom portion 1322, and an opening facing the bottom portion 1322. A cap plate 1332 in the cap assembly may be coupled with one end of the side wall portion 1324 to seal the opening. The cap plate 1332 may be welded to one end of the side wall portion 1324.

The finishing tape 1340 may be attached to the surface of the electrode assembly 1310. The finishing tape 1340 may be attached to wrap around at least a portion of the side and upper surfaces of the electrode assembly 1310. The finishing tape 1340 may be disposed to wrap around the upper surface of the electrode assembly 1310 within a range in which the finishing tape 1340 does not interfere with the connection between the electrode tab (e.g., the first electrode tab 112 of FIG. 1) connected to the electrode assembly 1310 and the terminal plate (e.g., the terminal plate 136 of FIG. 1).

Referring to FIG. 16, the finishing tape 1340 may include a buffer layer 1342 including a heat absorbing material and an adhesive layer 1344 disposed on at least one side of the buffer layer 1342.

In an embodiment, the finishing tape 1340 may include the first region 1340_1 and the second region 1340_2. The first region 1340_1 of the finishing tape 1340 may be disposed to wrap around the side of the electrode assembly 1310 and may be interposed between the side surface of the electrode assembly 1310 and the side wall portion 1324 of the case 1320. The second region 1340_2 of the finishing tape 1340 may be disposed to surround at least a portion of the upper surface of the electrode assembly 1310, and may be interposed between the upper surface of the electrode assembly 1310 and the cap plate 1332 or an insulating member (e.g., the insulating member 138 of FIG. 1) disposed below the cap plate 1332.

By this configuration, the finishing tape 1340 is folded along the upper surface of the electrode assembly 1310, so that heat generated in the welding area of the side wall portion 1324 of the case and the cap plate 1332 may be prevented from being transferred to the inside of the electrode assembly 1310 or the battery. In addition, during the process of welding the side wall portion 1324 of the case and the cap plate 1332, the finishing tape 1340 may be prevented from being caught in or interfering with the welding area.

For example, referring to FIG. 16, the buffer layer 1342 of the finishing tape 1340 may include a heat absorbing material. In another example, the buffer layer 1342 of the finishing tape 1340 may further include a thermally conductive material. Additionally or alternatively, the buffer layer 1342 of the finishing tape 1340 may include a plurality of buffer layers.

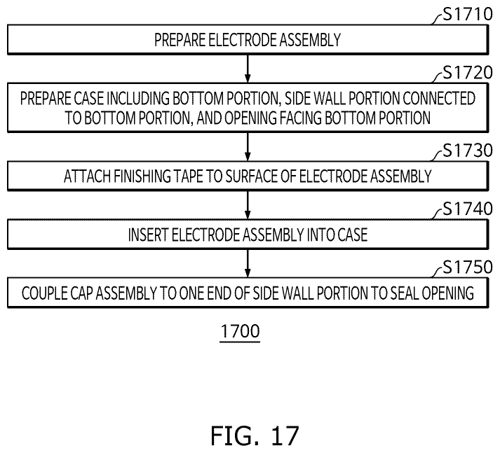

FIG. 17 is a flowchart illustrating a method 1700 of manufacturing a battery according to an embodiment of the present disclosure. The method 1700 of manufacturing a battery may be started by preparing an electrode assembly (S1710).

Additionally, a case including a bottom portion, a side wall portion connected to the bottom portion, and an opening facing the bottom portion may be prepared (S1720).

Then, a finishing tape may be attached to the surface of the electrode assembly (S1730). The finishing tape may be disposed to wrap around at least a portion of a side surface of the electrode assembly facing the side wall portion. Here, the finishing tape may include a buffer layer including a heat absorbing material. For example, at least a portion of the buffer layer may be made of a foamed resin substrate, and the inside of the foamed resin substrate may be filled with a heat absorbing material. Additionally, the buffer layer may further include a thermally conductive material.

In an embodiment, the finishing tape may include a first region and a second region extending from the first region. In this case, the step of disposing the finishing tape to wrap around at least a portion of a side surface of the electrode assembly may include a step of disposing a first region to be in contact with the side surface of the electrode assembly, and a second region to protrude beyond the side surface of the electrode assembly toward the opening.

In another embodiment, the step of disposing the finishing tape to wrap around at least a portion of a side surface of the electrode assembly may further include a step of folding the second region of the finishing tape along an upper surface of the electrode assembly facing the opening. In this case, the second region may be intermittently cut along the side perimeter of the electrode assembly.

Then, the electrode assembly may be inserted into the case (S1740).

Additionally, the cap assembly may be coupled to one end of the side wall portion to seal the opening (S1750).

The flow chart of FIG. 17 and the description above are only examples of the present disclosure, and the scope of the present disclosure is not limited to the flow chart of FIG. 17 and the description above. For example, one or more steps in the flowchart and/or the descriptions above may be added, changed, or deleted, the order of one or more steps may be changed, and one or more steps may be performed simultaneously.

By way of summation and review, a secondary battery may be manufactured by inserting an electrode assembly into a case and then sealing the case with a cap assembly. In this case, when the battery receives an external impact, cracks may occur in the electrode assembly or an electrode tab connected to the electrode assembly may come off. In addition, when heat exceeding a certain energy is generated inside the battery due to an abnormal chemical reaction of the battery, the temperature inside the battery may rise, potentially causing a battery short circuit or thermal runaway phenomenon.

In contrast, the present disclosure provides a battery with a finishing tape made of an impact-resistant material and a method of manufacturing the same. Accordingly, an external force transferred to the electrode assembly due to vibration, dropping, or external impact of the battery may be absorbed by the finishing tape, thereby minimizing damage to the electrode assembly.

According to some embodiments, the finishing tape may include a heat absorbing material. Accordingly, heat generated inside and outside the battery may be absorbed by the heat absorbing material, so that the temperature inside the battery may be prevented from rising above a certain temperature.

According to some embodiments, the adhesive layer of the finishing tape may include a thermally conductive material. Accordingly, the heat generated in the electrode assembly may be effectively transferred to the buffer layer of the finishing tape.

According to some embodiments, heat generated inside the battery may be effectively transferred to the finishing tape by a thermally conductive material inside the finishing tape. The increase in the temperature inside the battery may be prevented by the heat transferred to the finishing tape causing the heat absorbing material inside the finishing tape to react.

According to some embodiments, the finishing tape may include a first buffer layer including a thermally conductive material and a heat absorbing material, and a second buffer layer including a heat absorbing material. The first buffer layer of the finishing tape may be disposed to face the side surface of the electrode assembly, so that heat generated inside the battery may be quickly transferred to the finishing tape and absorbed. The second buffer layer of the finishing tape may be disposed to face the inner surface of the case, so that heat generated outside the battery may be absorbed before being transferred to the electrode assembly.

According to some embodiments, the finishing tape may be extended to protrude beyond the side surface of the electrode assembly, thereby preventing heat generated in the welding area of the side wall portion of the case and the cap plate from being transferred to the inside of the electrode assembly or the battery.

According to some embodiments, because the finishing tape is folded along the upper surface of the electrode assembly, heat generated at the welding area of the side wall portion of the case and the cap plate may be prevented from being transferred to the inside of the electrode assembly or the battery, and the finishing tape may be prevented from being caught in or interfering with at the welding area during the process of welding the side wall portion of the case and the cap plate.

According to some embodiments, because the outer perimeter of the electrode assembly is finished with a negative electrode substrate, the separator may be prevented from being caught between the case and the cap assembly or from being damaged by welding heat during the process of welding the case and the cap assembly.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. A battery, comprising:
an electrode assembly;
a case accommodating the electrode assembly, the case including a bottom portion, a side wall portion connected to the bottom portion, and an opening facing the bottom portion;
a finishing tape on a surface of the electrode assembly, the finishing tape including a buffer layer and a heat absorbing material; and
a cap assembly coupled to one end of the side wall portion to seal the opening.

2. The battery as claimed in claim 1, wherein:
at least a portion of the buffer layer includes a foamed resin substrate, and
an inside of the foamed resin substrate is filled with the heat absorbing material.

3. The battery as claimed in claim 1, wherein the finishing tape is wrapped around at least a portion of a side surface of the electrode assembly facing the side wall portion.

4. The battery as claimed in claim 3, wherein the finishing tape includes:
a first region in contact with the side surface of the electrode assembly; and
a second region extending from the first region and protruding beyond the side surface of the electrode assembly, the second region extending toward the opening.

5. The battery as claimed in claim 4, wherein the second region is folded along an upper surface of the electrode assembly facing the opening.

6. The battery as claimed in claim 5, wherein the second region includes intermittent cuts along a side perimeter of the electrode assembly.

7. The battery as claimed in claim 1, wherein the buffer layer further includes a thermally conductive material.

8. The battery as claimed in claim 1, wherein:
the buffer layer includes a first buffer layer and a second buffer layer on the first buffer layer,
the first buffer layer faces a side surface of the electrode assembly, and
the second buffer layer faces the side wall portion of the case.

9. The battery as claimed in claim 8, wherein the first buffer layer further includes a thermally conductive material.

10. The battery as claimed in claim 1, wherein an endothermic reaction temperature of the heat absorbing material is 100 degrees to 300 degrees.

11. The battery as claimed in claim 1, wherein the finishing tape further includes an adhesive layer on at least one side of the buffer layer.

12. The battery as claimed in claim 11, wherein the adhesive layer includes a thermally conductive material.

13. The battery as claimed in claim 1, wherein:
the electrode assembly includes a wound structure of a first electrode, a second electrode, and a separator between the first electrode and the second electrode, and
a substrate of the second electrode is extended and wound to wrap around an outer perimeter of a side surface of the electrode assembly.

14. A method of manufacturing a battery, the method comprising:
preparing an electrode assembly;
preparing a case including a bottom portion, a side wall portion connected to the bottom portion, and an opening facing the bottom portion;
attaching a finishing tape to a surface of the electrode assembly, the finishing tape including a buffer layer and a heat absorbing material;
inserting the electrode assembly into the case; and
coupling a cap assembly to one end of the side wall portion of the case to seal the opening.

15. The method of manufacturing a battery as claimed in claim 14, wherein attaching the finishing tape includes disposing the finishing tape to wrap around at least a portion of a side surface of the electrode assembly facing the side wall portion.

16. The method of manufacturing a battery as claimed in claim 15, wherein:
the finishing tape includes a first region and a second region extending from the first region, and
disposing the finishing tape to wrap around at least a portion of a side surface of the electrode assembly includes disposing the first region to be in contact with the side surface of the electrode assembly, and disposing the second region to protrude beyond the side surface of the electrode assembly toward the opening.

17. The method of manufacturing a battery as claimed in claim 16, wherein disposing the finishing tape to wrap around the portion of the side surface of the electrode assembly includes folding the second region along an upper surface of the electrode assembly facing the opening.

18. The method of manufacturing a battery, as claimed in claim 17, wherein the second region is intermittently cut along a side perimeter of the electrode assembly.

19. The method of manufacturing a battery, as claimed in claim 14, wherein:
at least a portion of the buffer layer includes a foamed resin substrate, and
an inside of the foamed resin substrate is filled with the heat absorbing material.

20. The method of manufacturing a battery, as claimed in claim 14, wherein the buffer layer further includes a thermally conductive material.
